(19) United States
(12) Patent Application Publication
(10) Pub. No.: US 2017/0045424 A1
(43) Pub. Date: Feb. 16, 2017

(54) SLAG CAP

(71) Applicants: Mirelle Maenhoudt, (US); Heraeus Electro-Nite International N.V., Houthalen (BE)

(72) Inventor: Johan KNEVELS, Bree (BE)

(21) Appl. No.: 15/229,614

(22) Filed: Aug. 5, 2016

(30) Foreign Application Priority Data
Aug. 12, 2015 (EP) 15 180 714.6

(51) Int. Cl. G01N 1/12

(52) U.S. Cl. CPC G01N 1/125

(57) ABSTRACT

A sampling device for molten metals includes a carrier tube having an immersion end and a sample chamber arranged in the carrier tube. The sample chamber has an inflow conduit. The inflow conduit has an inflow opening inside the sampling chamber and an outer open end which is surrounded by a protective cap. The protective cap has a metallic body with an inner side directed toward the inflow conduit and an outer side. A layer of a material is arranged at the outer side of the metallic body. The material comprises a compound which decomposes and forms water vapor if immersed in molten steel, molten iron or molten slag.

### BACKGROUND OF THE INVENTION

The present invention relates to a sampling device for molten metals comprising a carrier tube having an immersion end, and a sample chamber arranged in the carrier tube and having an inflow conduit with an inflow opening inside the sampling chamber and with an outer open end of the inflow conduit. The outer open end of the inflow conduit is surrounded by a protective cap. The protective cap has a metallic body with an inner side directed towards the inflow conduit and an outer side. The present invention further relates to a cap and its use.

Sampling devices or probes for extracting a sample of molten steel from a steel bath are well known in the art and provide a coupon or disc of solid metal for use in spectrographic analysis. These devices are generally constructed containing small molds or a mold cavity to be filled with liquid steel as the sampler is dipped into the metal bath. The term liquid or molten steel or steel bath is to be understood in a rather wide sense; it is to include, e.g., cast iron melts, steel alloys as well as non-ferrous metal melts.

Sampling devices of the type referred to above generally, and of known construction, include a cardboard carrier tube supporting a housing, which contains a multi-part mold. Communicating between the liquid metal and the molten bath is an inflow conduit normally of quartz glass and may contain deoxidants.

During the processing of molten metals, the liquid metal to be sampled usually has a cover of slag or dross which may be entirely liquid, solid or a combination thereof. U.S. Pat. No. 3,686,949 teaches that the immersion end of the sampling device, especially the inflow conduit should be protected from the slag layer atop the metal bath during immersion by a protective cap. This cap prevents slag from entering the sampling chamber. The protective cap melts after immersing below the slag layer, and thus the inflow is exposed only to the desired melt. Also, certain slags may freeze on the protective cap delaying the opening and/or dragging the undesirable slag into the metal sampling vicinity. To counteract the effect of slag freezing, an additional cover formed of laminated assemblies of paper or plastic, which vaporize with enough turbulence, is provided to avoid such undesired slag deposits on the cap.

U.S. Pat. No. 4,046,016 teaches that the covering of paper or similar material serves two purposes. In burning off, it volatilizes explosively, removing the encrusted slag and also by selecting materials of proper thickness, total burn-off time can be extended to provide control over sampling immersion depths.

Although the combination of a paper cover over a metal cap provides a solution for a majority of molten metal sampling conditions, there are critical grades of metals that during processing require exceptional purity in sampling due to the ultralow concentration of elements dissolved in the sampled metal.

U.S. Pat. No. 4,941,364 recognizes that prior art samplers for steel have been designed with protective capping and an entrance system that melted along with and were entrained into the molten material being sampled. During the sampling of extremely low concentrations, typically 10-50 ppm of certain elements such as C, S, N, the prior art protective covers resulted in either the addition of undesirable contaminants to flow into the actual sample chamber or allowed elements contained in the capping system to cause a diluting effect on similar elements contained in the molten batch material. To avoid contamination, a non-reactive alumina-silicate ceramic is provided which is held together by a retaining device adapted to Pail upon contact with the molten metal, thus releasing the portions of the protective cover so that they will separate and float upwards. This complicated and high cost structure was only applicable to a narrow range of high temperature sampling conditions.

When the liquid metal to be sampled is very close to the temperature of its solidification, such as in the tundish for continuous casting of ultralow carbon steel, this combination imposes unique problems. During immersion in metals near their freezing point, the slag covering is typically also thick and viscous and easily solidified onto the cold immersion sampler. The sampler inflow must be protected from the effects of floating slag, which must not be allowed to freeze on the cold sampler and block the sampling operation. At the same time, any metal cover protecting the inflow conduit of the sampler must not be so thick as to retard the melting, and thus unnecessarily delay or prevent the entrance of the molten metal to be sampled.

It is known for aluminum killed ultralow carbon steel, especially baked hardened automotive grades where the carbon in solution in the ferrite phase is responsible for their good formability and high strength after paint baking, that a narrow range of carbon content is required. U.S. Pat. No. 5,014,561 teaches away from the use of metal caps inflow coverings and to use low melting temperature glasses, such as Pyrex, in the near liquidus sampling conditions thus avoiding any carbon contamination. U.S. Pat. No. 5,448,923 proposes thin metal slag covers of comparable very low carbon steel with a composition of the sampled steel, and thus avoid introducing undesired carbon to the sample. These caps are slit to promote melting. Despite recognition of the difficulty in ultralow element sampling in near liquidus conditions, the prior art has failed to recognize and provide a solution that eliminates the contamination arising from the paper and/or plastic covering that prevent freezing of the slag.

### BRIEF SUMMARY OF THE INVENTION

It is an objective of the present invention to improve the known samplers and to allow a more accurate measurement of elements having low concentrations.

The present invention relates to a sampling device for obtaining samples from liquid metals such as iron, steel or other metals and metal alloys provided with a protective cap coated with a decomposing layer, resulting in a water vapor layer to avoid freezing of slag to the protective cap during immersion. A cap in the sense of the present invention is a technical device, having an essentially convex shape with an opening, an outer side and an inner side limiting an inner hollow space. The cap may be used as the closure of an opening.

The present invention is directed to a sampling device for molten metals comprising a carrier tube having an immersion end, and a sample chamber arranged in the carrier tube and having an inflow conduit with an inflow opening inside the sampling chamber and with an outer open end of the inflow conduit whereby the outer open end of the inflow conduit is surrounded by a protective cap. The protective cap has a metallic body with an inner side, directed towards the inflow conduit and an outer side. At the outer side of the protective cap, a layer of a material is arranged, wherein the material comprises a compound which decomposes and forms water vapor if immersed in molten steel or molten iron or molten slag.

Preferably, the compound of the layer of material comprises at least one metal hydroxide or at least one hydrated metal salt or a mixture of the at least one metal hydroxide and the at least one hydrated metal salt and a binder, preferably a water glass binder. Aluminum hydroxide, as a relatively cheap and easily applicable material, or magnesium hydroxide may be used as the compound for the layer. Both materials are acceptable and usable to create the water vapor protection. It may also be possible to use calcium hydroxide or water glass as the compound of the layer of material.

In a preferred embodiment, the inflow conduit and the sampling chamber of the sampling device are at least partially arranged in a housing of a refractory material, wherein the housing is arranged at the immersion end of the carrier tube, in order to improve mechanical and thermos-resistance of the device during immersion. The protective cap can be arranged at the housing to improve stability before immersion.

Further, it can be advantageous that a sensor, preferably a temperature sensor or an electrochemical sensor, is arranged at the immersion end of the carrier tube to also take measurements simultaneously.

The present invention is further directed to a cap having a metallic body with an inner side and an outer side, wherein at the outer side of the cap, a layer of a material is arranged. The material comprises a compound which decomposes and forms water vapor if immersed in molten steel or molten iron or molten slag.

The present invention is further directed to the material for use as a layer, preferably as a layer of a cap whereas the layer comprises a compound, which may comprise a binder, preferably a water glass binder. The compound decomposes to forms water vapor if immersed in molten iron or molten steel or molten slag.

In a preferred embodiment, the compound of the layer comprises at least one metal hydroxide or at least one hydrated metal salt or a mixture of the at least one metal hydroxide and the at least one hydrated metal salt. Aluminum hydroxide, in particular, is a relatively cheap and easily applicable material, as the compound for the layer of material. Alternatively, magnesium hydroxide may be used as the compound for the layer of material. Both materials are suitable for use to create the water vapor protection. It may also be possible to use calcium hydroxide or water glass as the compound of the layer of material.

Another aspect of the present invention is the use of the cap as protective cap of a sampling device or a sensor device.

The inventive coating on the protective cap is not carbon containing, and therefore cannot contribute to an error in carbon by addition. The water vapor releasing compound, as well as the water releasing binder, can be selected from those base elements that are either not analyzed in a typical spectrographic sample or belong to the group of analyzed elements, which are not critical for that analysis. Typical in aluminum killed ultralow carbon samples, it is critical that the carbon content is detectable within a few ppm. It had been observed that the release of water vapor did not result in gas voids in the sample as one normally skilled in the art would expect.

The present invention applies to a coating of, but not limited to, metallic hydroxides such as Al(OH)₃ or Mg(OH)₂. These compounds decompose at a relatively low temperature as follows: 2 Al(OH)₃→Al 2O₃+3H²O, thus absorbing a large amount of heat while producing a surface gas (water vapor) layer. The volume expansion of water vapor at the slag/coating surface results in a contiguous rejection layer during immersion, preventing the sticking of slag to the base steel cap. One skilled in the art can recognize that other like compounds, such as, but not limited to, other metal hydrides and hydrated salts that release water upon their decomposition are suitable. Such suitable compounds could also be Ca(OH)₂ or hydrated compounds such as Na₂SO₄.10H₂O or MgCl₂.6H₂O.

The present invention applies to a coating comprising a binder such as sodium silicate or potassium silicate. This binder decomposes at a temperature below the iron or steelmaking temperature and releases water Vapor, adding in the generation or a surface gas layer on the protective cap. Additionally, the synergistic setting property of sodium silicate and hydroxides of Al, Ca, Mg, or alternately one could use setting agents such as CaCl₂, NaH₂BO₃, H₂SO₄, improve the hardness of the coating. One skilled in the art cart recognize that other like binders, such as, but not limited to silicates, which decompose to water vapor are suitable.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 shows a schematic view of a sampler according to an embodiment of the present invention; and

FIG. 2 shows details of an inventive sampler.

### DETAILED DESCRIPTION OF THE INVENTION

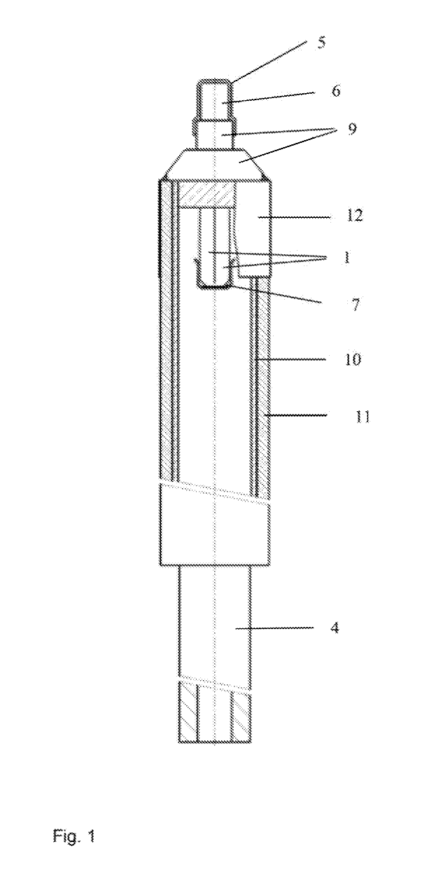

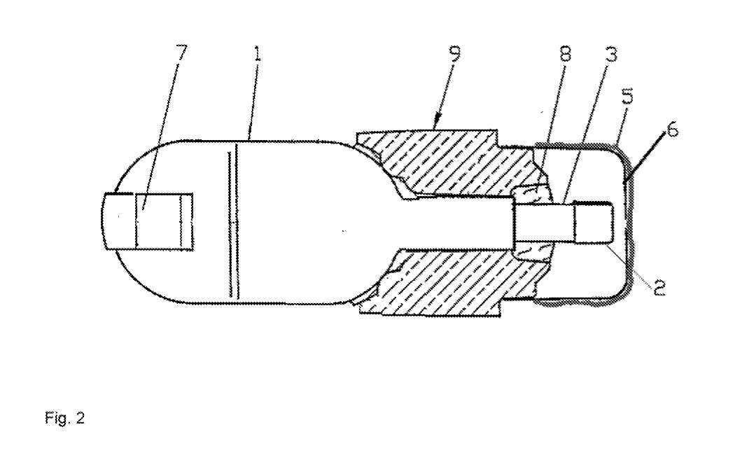

According to the present invention, a refractory housing 9, preferably made of cordierite, of the sampler is arranged at the immersion end of a cardboard carrier tube 4. At the outer surface of the immersion end of the cardboard tube 4, a cardboard sleeve 10 is arranged, which is covered by a non-splash sleeve 11 (FIG. 1). The immersion end of the non-splash sleeve 11 is surrounded by an adhesive tape 12. Two mold halves 1 of a sampling chamber and an inflow conduit 3 (FIG. 2) are mounted in the refractory housing 9. Attached to the immersion end of the refractory housing 9 is an outer protective cap 6, coated by a layer 5 of a water vapor forming compound.

Mating molds halves 1 of the sampling chamber to receive molten metal are held together by a dip 7. An elongated portion of the mold halves 1 receives the inflow conduit 3 which is fixed by cement 8. The mold halves 1 and the inflow conduit 3 are cemented into the refractory housing 9, which is held by the cardboard carrier tube 4, for immersion. The inflow conduit 3 is closed by an inner cap 2, preferably formed of ultralow carbon steel. Attached to the housing is the outer projectile cap 6, which has an inner side which is directed toward the housing and the inflow conduit 3, and an outer side coated by a layer 5 of a water vapor forming compound, preferably aluminum hydroxide. The layer 5 has a thickness of 0. to 0.5 mm.

A first example of a suitable coating layer 5 may contain between 35 to 55 g aluminum hydroxide powder, preferably 45 g aluminum hydroxide powder, may have a powder size of 20 to 40 μm, preferably 30 μm and may contain 50 to 100 g, preferably 70 g, water glass of approximately 38 Baumé (1.35 g/ml). The water glass has a weight ratio modulus SiO₂/Na₂O of about 3.65.

A second example of a suitable coating layer 5 may contain between 35 to 55 g aluminum hydroxide powder, preferably 45 c aluminum hydroxide powder; 30 to 50 g. preferably 40 g, silica sand having an average grain sin of about 47 μm and a density of about 1.15 g/cm³; and 120 to 160 g, preferably 140 g, water glass of approximately 38 Baumé (1.35 g/ml). The water class has a weight ratio modulus SiO₂/Na₂O of about 3.65.

A third example of a suitable coating layer 5 may contain between 40 to 60 g magnesium hydroxide powder, preferably 50 g magnesium hydroxide powder; 30 to 50 g, preferably 40 g, silica sand having an average grain size of about 47 μm and a density of about 1.15 g/cm³; and 120 to 160 g, preferably 140 g, water class of approximately 38 Baumé (1.35 g/ml). The water glass has a weight ratio modulus SiO₂/Na₂O of about 3.65.

A fourth example of a suitable coating layer 5 may contain 100 g of a powder of between 40 to 60% by weight magnesium hexahydrate powder, MgCl₂.6H₂O, of a density of approximately 1.57 g/cm ³, preferably 50% by weight magnesium hexahydrate powder, 40 to 60% by weight, preferably 50% by weight, silica sand of a density of about 1.15 g/cm³; and a liquid binder of potassium silicate, 120 to 160 g, preferably 140 g with a weight ratio of K/Na₂O of 2.5.

A fifth example is a mixture of (1) 1040 g aluminum hydroxide, (2) 800 g sand, (3) 2800 g sodium silicate and (4) 130 g water. The water lowers the viscosity and leads to easier application of the layer. The layer will be dried, wherein the water as well as some water of the sodium silicate will be removed. The coating of the final product has a composition of (1) 1040 g aluminum hydroxide, (2) 800 g sand and (3) 2366 g sodium silicate (with (4) water being 0 g after drying). The percentage of the three main components (1), (2) and (3) is preferably in the range of (1) from 20 to 25% by weight, (2) from 15 to 20% by weight and (3) from 55 to 65%, respectively, by weight of the total weight of these three components.

One skilled in the art of coating will understand that the wetting coefficient of silicate binders decreases as the viscosity increases. Control of the viscosity of the coating is a practical matter known in the art whereas aside from adding relatively small additions of water to the mixture, the viscosity can also be reduced by small additions of potassium hydroxide or by simply increasing the liquid temperature, As such, deviations from the prescribed ratio of solids to liquids or small additions to the base mixture to control the viscosity are tolerated without departure from the scope of the present invention.

Preferably 2-3 g of coating can be applied by conventional dip coating processes and allowed to air dry until dry to the touch.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A sampling device for molten metals comprising:
a carrier tube having an immersion end; and
a sample chamber arranged in the carrier tube and having an inflow conduit, the inflow conduit having an inflow opening inside the sampling chamber and an outer open end which is surrounded by a protective cap, the protective cap having a metallic body with an inner side directed toward the inflow conduit and an outer side,
wherein a layer of a material is arranged at the outer side of the metallic body, and
wherein the material comprises a compound which decomposes and forms water vapor if immersed in molten steel, molten iron or molten slag.

2. A sampling device according to claim 1, wherein the compound of the material of the layer comprises at least one metal hydroxide, at least one hydrated metal salt, or a mixture of the at least one metal hydroxide and the at least one hydrated metal salt.

3. A sampling device according to claim 1, wherein the compound of the material of the layer comprises a binder preferably a water glass binder.

4. A sampling device according to claim 1, wherein the compound of the material of the layer is aluminum hydroxide or magnesium hydroxide.

5. A sampling device according to claim 1, wherein the compound of the material of the layer is calcium hydroxide.

6. A sampling device according to claim 1, further comprising a housing of a refractory material arranged at the immersion end of the carrier tube, wherein the inflow conduit and the sampling chamber are at least partially arranged in the housing.

7. A sampling device according to claim 6, wherein the protective cap is arranged at the housing.

8. A sampling device according to claim 1, further comprising a sensor, preferably a temperature sensor or an electrochemical sensor, arranged at the immersion end of the carrier tube.

9. A cap having a metallic body with an inner side and an outer side, wherein a layer of a material is arranged at the outer side of the metallic body, and wherein the material comprises a compound and/or a binder which decomposes and forms water vapor if immersed in molten steel, molten iron or molten slag.

10. A cap according to claim 9, wherein the compound of the material of the layer comprises at least one metal hydroxide, at least one hydrated metal salt, or a mixture of the at least one metal hydroxide and the at least one hydrated metal salt.

11. A cap according to claim 9, wherein the compound is aluminum hydroxide or magnesium hydroxide.

12. A cap according to claim 9, wherein the compound is calcium hydroxide.

13. A cap according to claim 9, wherein the compound is water glass.

14. Use of a cap according to claim 1 as a protective cap of a sampling device or a sensor device.

15. A material for use as a layer, preferably as a layer of a cap according to claim 9, wherein the material comprises a compound which decomposes to form water vapor if immersed in molten iron, molten steel or molten slag.

16. A material according to claim 15, wherein the compound comprises a binder, preferably a water glass binder.
